(19) United States
(12) Patent Application Publication
(10) Pub. No.: US 2017/0175840 A1
(43) Pub. Date: Jun. 22, 2017

(54) Cylinder, In Particular For A Tuned Mass Damper, Having A Sleeve-Shaped Add-On Piece

(71) Applicant: ZF Friedrichshafen AG, Friedrichshafen (DE)

(72) Inventors: Hartmut RÖLLEKE, Kircheib (DE); Dirk BECKER, Willroth (DE); Klaus SCHREINER, Windeck (DE); Wolfgang HERTZ, Sankt Augustin (DE)

(21) Appl. No.: 15/116,053

(22) PCT Filed: Jan. 8, 2015
(86) PCT No.: PCT/EP2015/050208

§ 371 Date: Aug. 2, 2016

(30) Foreign Application Priority Data
Feb. 6, 2014 (DE) 10 2014 202 211.8

(51) Int. Cl. F16F 9/32

(52) U.S. Cl. CPC F16F 9/3242

(57) ABSTRACT

A cylinder (1), particularly for a vibration damper, includes a base (3) and a sleeve-shaped add-on part (5) which at least partially surrounds the cylinder (1) and which has at an end of the cylinder a radially inwardly directed edge profile. The edge profile (11) contacts an end face of the cylinder (1) in a noncontacting manner with respect to the base.

### PRIORITY CLAIM

This is a U.S. national stage of application No. PCT/EP2015/050208, filed on Jan. 8, 2015. Priority is claimed on the following application: Country: Germany, Application No.: 10 2014 202 211.8, Filed: Feb. 6, 2014, the content of which is/are incorporated in its entirety herein by reference.

### FIELD OF THE INVENTION

The invention is directed to a cylinder, particularly for a vibration damper, with a sleeve-shaped add-on part according to the preamble of patent claim 1.

### BACKGROUND OF THE INVENTION

A cylinder for a vibration damper is known from DE 33 12 753 C2. The cylinder has a base which is formed integral with the cylinder and which has an outwardly curved surface. A base of this type offers the advantage of high strength.

A sleeve-shaped add-on part constructed as a steering knuckle is fastened to the cylinder. For purposes of a good support and transmission of force between the cylinder and the add-on part, the add-on part has an edge profile which is directed radially inward and which contacts the outwardly curved base. Accordingly, the angle formed between the cylinder and the base is greater than 90°. Therefore, a weld joint between the base and the edge profile is described as especially advantageous for preventing the edge profile from bending up.

### SUMMARY OF THE INVENTION

It is an object of the present invention to realize an axial support of the cylinder with respect to the add-on part by which a weld between the add-on part and the base of the cylinder can be dispensed with.

According to the invention, this object is met in that the edge profile of the add-on part contacts an end face of the cylinder in a noncontacting manner with respect to the base.

The great advantage of the invention consists in that the base contour of the cylinder exerts no influence on the edge profile of the add-on part. Accordingly, an edge profile with a ninety-degree bend can be used even with a spherically shaped cylinder base.

In a further advantageous configuration, it is provided that the cylinder base is constructed as a separate component part with respect to the cylinder. Accordingly, the base can be adapted in a simpler manner to the angled edge profile so that there is no contact between the base and the edge profile.

Further, the base can be arranged at an axial distance from the nearest end of the cylinder. In this way, a spatial separation between the add-on part and the cylinder base is ensured in a very simple manner. Further, a standardized base profile can be used. A standardized base and a standardized cylinder can also be used for different working space volumes of the cylinder.

To achieve a particularly high carrying capacity of the joint between the cylinder and the add-on part, the edge profile is constructed as a circumferential groove. The edge profile is strengthened appreciably compared to a simple bend of the edge profile.

In a further advantageous configuration, the cylinder has a radial formed-on portion with respect to the end face, which formed-on portion provides a free space for a transition contour between a sleeve region and the edge profile of the add-on part. Accordingly, a particularly small transition radius can be formed between the sleeve region and the edge profile, which in turn has a strengthening effect.

A variant having an especially high carrying capacity is characterized in that the groove profile has a groove width which substantially corresponds to the thickness of the cylinder. A radially double-sided clamping connection can be achieved between the cylinder and the add-on part in the region of the groove profile.

In a further variation, the edge profile is constructed as a circumferential groove on which the base of the cylinder is supported. A circumferential groove is highly dimensionally stable and is practically incapable of widening so that large carrying forces can be transmitted.

In a particularly simple construction of the groove, the base of the cylinder is axially supported on an end face of the circumferential groove.

### BRIEF DESCRIPTION OF THE DRAWINGS

The invention will be described more fully with reference to the following description of the drawings in which:

FIG. 1 shows the cylinder used in a vibration damper;

FIG. 2A is a sectional view of an add-on part with a bent edge profile;

FIG. 2B is an enlarged sectional view of FIG. 2A; and

FIG. 3 is a sectional view of another embodiment of the add-on part with a groove profile.

### DETAILED DESCRIPTION OF THE PRESENTLY PREFERRED EMBODIMENTS

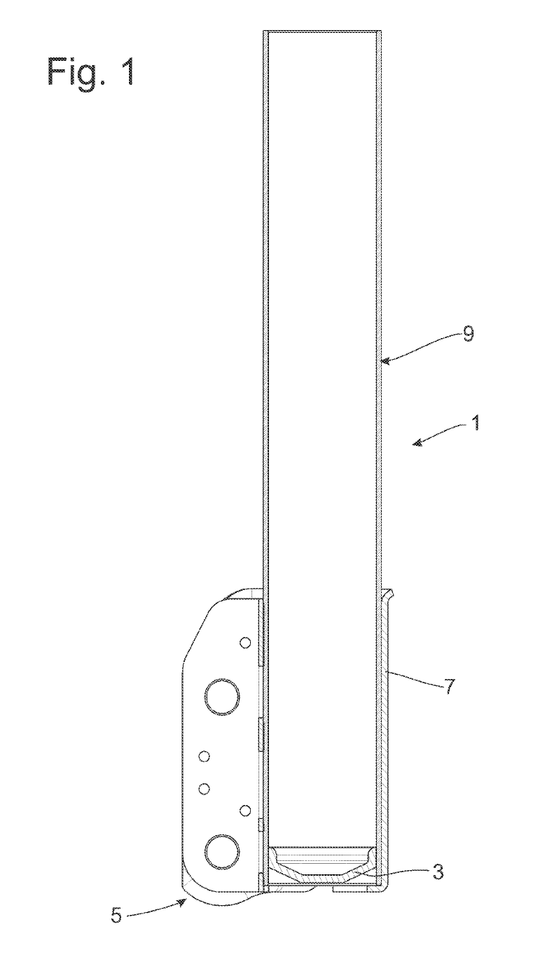

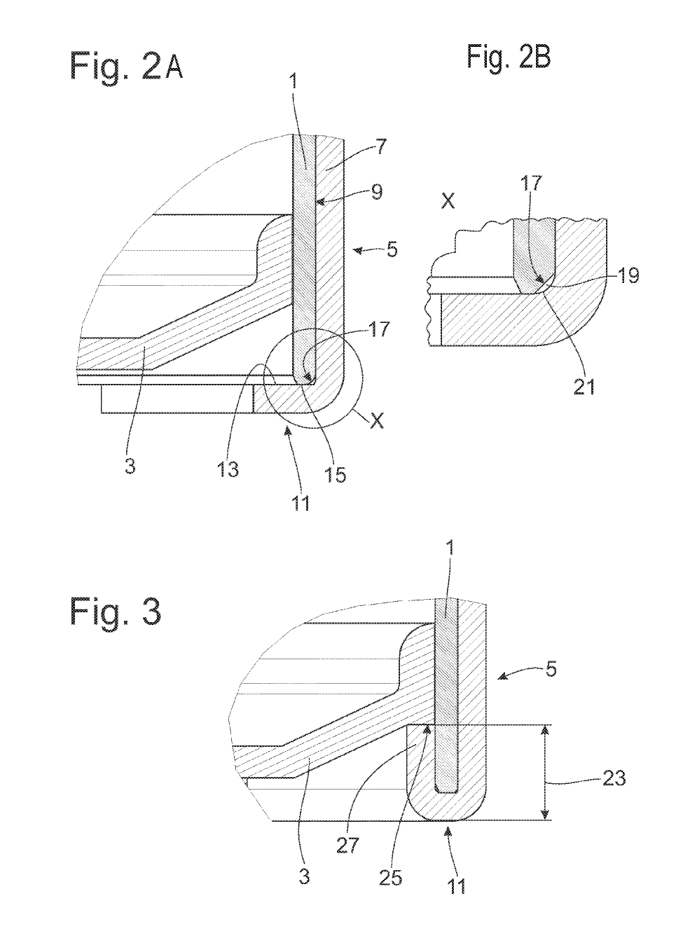

FIG. 1 shows a cylinder 1 with a base 3 as part of a vibration damper, known per se, of any construction. A sleeve-shaped add-on part 5 is fastened to the cylinder 1 and at least partially surrounds the cylinder 1. The add-on part 5 is a steering knuckle receptacle or axle knuckle receptacle, for example. The add-on part has a sleeve region 7 which is preferably fixed to an outer lateral surface 9 of the cylinder 1 by means of an interference fit. As can be seen particularly when viewed in conjunction with FIG. 2, the add-on part 5 is arranged at an end of the cylinder 1. Adjoining the sleeve region 7 is a radially inwardly directed edge profile 11. The add-on part 5 is preferably formed as a bent sheet metal part, and the edge profile 11 contacts an end face 15 of the cylinder 1 by an inner side 13, but without contacting the base 3.

The base 3 is constructed as a component part that is separate from the cylinder 1 and has a spherical configuration. The connection between the base 3 and the cylinder 1 can be realized, e.g., via a weld joint, not shown. There is an axial distance between the base 3 and a nearest end of the cylinder 1. The base can accordingly be freely configured to a very large degree without contact occurring between the edge profile 11 and the base 3.

At the transition to the end face 15, the cylinder 1 has a radial formed-on portion 17 which provides a free space 19 for a transition contour 21 between the sleeve region 7 and the edge profile 11. Accordingly, a bending radius of less than 1 mm can be formed between the edge profile 11 and the sleeve region 7.

FIG. 3 shows a further development of the construction according to FIG. 2. In contrast to FIG. 2, the edge profile 11 is constructed as a circumferential groove. The groove can also be configured so as to be segmented in circumferential direction. There is also the possibility that the groove profile has a groove width which substantially corresponds to the thickness of the cylinder 1. When the groove profile is rolled up to the axial protrusion of the cylinder 1 relative to the base 3, a two-sided clamping region 23 can be provided between the add-on part 5 and the cylinder 1. It can also be provided that the base is supported on an end-side end face 25 of a bent leg 27 of the circumferential groove 11. In this case, a weld or bead, for example, between the cylinder 1 and the base 3 can be dispensed with.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A cylinder (1) for a vibration damper, comprising:
a base (3) and a sleeve-shaped add-on part (5) at least partially surrounding said cylinder (1), said add-on part (5) having, at an end of said cylinder (1), a radially inwardly directed edge profile (11), said edge profile (11) contacting an end face (15) of said cylinder (1) but is not in contact with said base (3).

10. The cylinder according to claim 9, wherein said base (3) is constructed as a separate component part with respect to said cylinder (1).

11. The cylinder according to claim 9, wherein said base (3) is arranged at an axial distance from the nearest end of said cylinder (1).

12. The cylinder according to claim 9, wherein said edge profile (11) is constructed as a circumferential groove.

13. The cylinder according to claim 9, wherein said cylinder (1) comprises a radial formed-on portion (17) with respect to said end face (15), said formed-on portion (17) providing a free space (19) for a transition contour (21) between a sleeve region (7) and said edge profile (11) of said add-on part (5).

14. The cylinder according to claim 12, wherein said edge profile (11) has a groove width substantially corresponding to the thickness of said cylinder (1).

15. A cylinder (1), for a vibration damper, comprising:
a base (3) and a sleeve-shaped add-on part (5) at least partially surrounding said cylinder (1), said add-on part (5) having, at an end of the cylinder (1), a radially inwardly directed edge profile (11), wherein said edge profile (11) is constructed as a circumferential groove for supporting said base (3).

16. The cylinder according to claim 15, wherein said base (3) is axially supported on an end face of said circumferential groove (11).
